(19) United States
(12) Patent Application Publication
(10) Pub. No.: US 2022/0279968 A1
(43) Pub. Date: Sep. 8, 2022

(54) BARBECUE GRILL

(71) Applicant: CHIA MING LIU, DOULIU CITY (TW)

(72) Inventors: CHIA MING LIU, DOULIU CITY (TW); HSIN MING HUANG, CHANGHUA COUNTY (TW)

(21) Appl. No.: 17/213,727

(22) Filed: Mar. 26, 2021

(30) Foreign Application Priority Data
Mar. 2, 2021 (CN) 202120452919.X

(51) Int. Cl. A47J 37/07; F24C 3/12; F23N 1/00; A47J 36/32

(52) U.S. Cl. CPC A47J 37/0745; F24C 3/126; F23N 1/005; A47J 36/32; A47J 37/0713; A47J 37/0786; F23N 2235/16; F23N 2235/14; A47J 2202/00; A47J 2037/0795

(57) ABSTRACT

A barbecue grill has a body, a barbecue grid, a heating device, a heating adjustment unit, a thermal sensor, and a control device. The heating adjustment unit is connected with the heating device. The thermal sensor is mounted in the body and detects an actual temperature. The control device has a constant temperature control module electrically connected to the heating adjustment unit and the thermal sensor. The constant temperature control module controls the heating adjustment unit to adjust heat output of the heating device according to a difference value between a target temperature and the actual temperature. The heat output of the heating device is increased or decreased according to the difference value to keep the temperature constant at the position of the thermal sensor.

### BACKGROUND OF THE INVENTION

### 1. Field of the Invention

The present invention relates to a barbecue grill, and more particularly to a barbecue grill that can provide a constant heating temperature at a position of a barbecue grid of the barbecue grill.

### 2. Description of Related Art

A conventional barbecue grill has a body, a heating source, and a barbecue grid. The heating source, which can be charcoal fire, fire generated by a heating device, or electric heating generated by an electric heating device, is mounted in the body. The barbecue grid is held in the body at a position above the heating source. Foods on the barbecue grid are grilled by the heating source.

However, an actual temperature at a position of the barbecue grid will be changed by heat output of the heating source, heating time, a distance between the barbecue grid and the heating source, and other environmental factors. Even if the heating source is generated by a heating device with a stable heating output, the actual temperature at the position of the barbecue grid still may change. So foods on the barbecue grid are easily underbaked or overbaked. The conventional barbecue grill cannot provide a constant heating temperature to heat foods on the barbecue grid.

To overcome the shortcomings, the present invention tends to provide a barbecue grill that can provide a constant heating temperature at a position of the barbecue grid to mitigate or obviate the aforementioned problems.

### SUMMARY OF THE INVENTION

The main objective of the present invention is to provide a barbecue grill that can provide a constant heating temperature at a position of a barbecue grid of the barbecue grill.

The barbecue grill comprises a body, a barbecue grid held in the body, a heating device mounted in the body, a heating adjustment unit connected with the heating device, a thermal sensor mounted in the body and detecting an actual temperature of a position of the thermal sensor, and a control device. The control device has a constant temperature control module electrically connected to the heating adjustment unit and the thermal sensor, determining a difference value between a target temperature and the actual temperature detected by the thermal sensor, and controlling the heating adjustment to adjust heat output of the heating device according to the difference value.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a barbecue grill in accordance with the present invention;

FIG. 2 is an enlarged perspective view of the barbecue grill in FIG. 1, wherein some components of the barbecue grill are omitted;

FIG. 3 is a further enlarged perspective view in partial section of the barbecue grill in FIG. 1, wherein some components of the barbecue grill are omitted;

FIG. 4 is an enlarged perspective view of the barbecue grill in FIG. 1 showing that a control device is pulled out from a body of the barbecue grill;

FIG. 5 is an enlarged perspective view of a heating device mounted in the barbecue grill in FIG. 1;

FIG. 6 is an enlarged front side view in partial section of the barbecue grill in FIG. 1,

FIG. 7 is an enlarged operational front side view in partial section of the barbecue grill in FIG. 1;

FIG. 8 is a block diagram of the control device of the barbecue grill in FIG. 1;

FIG. 9 is a flow chart of a constant temperature control module of the barbecue grill in FIG. 1;

FIG. 10 is a block diagram of the heating device of the barbecue grill in FIG. 1; and

FIGS. 11 and 12 are enlarged operational front side views in partial section of the barbecue grill in FIG. 1.

### DETAILED DESCRIPTION OF THE PREFERRED EMBODIMENT

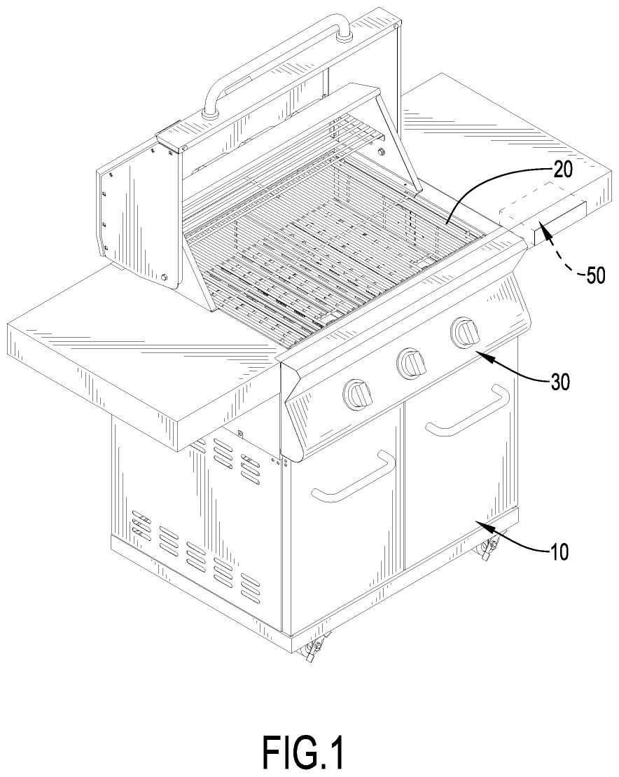

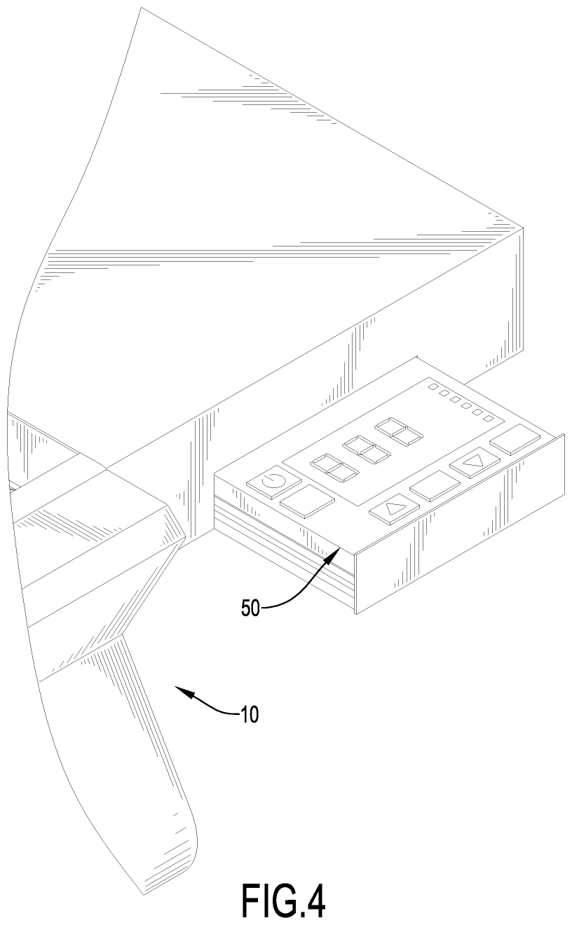

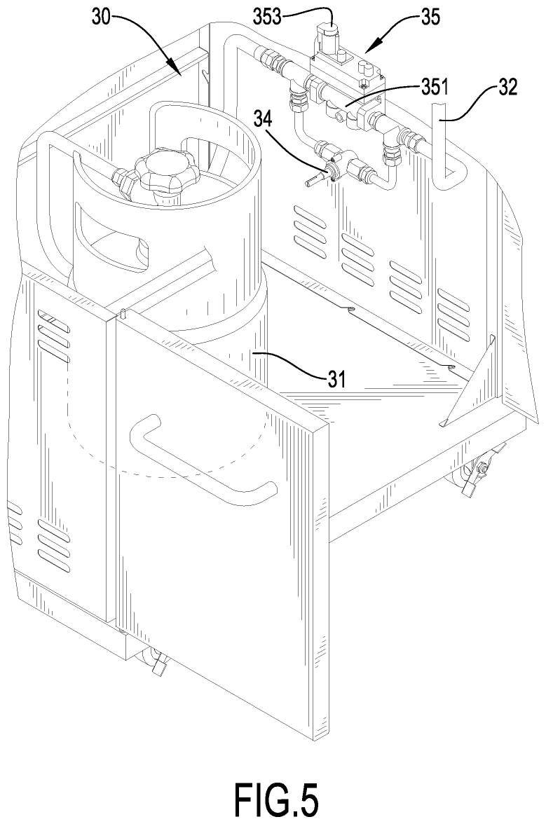

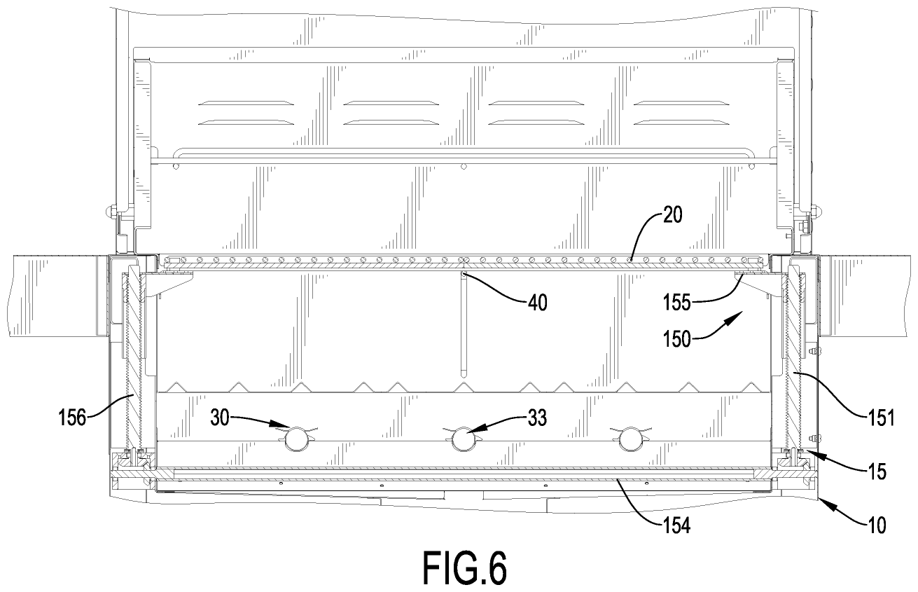

With reference to FIGS. 1 to 6, a barbecue grill in accordance with the present invention includes a body 10, a barbecue grid 20, a heating device 30, a heating adjustment unit 35, a thermal sensor 40, and a control device 50.

The barbecue grid 20 is held in the body 10. The heating device 30 is mounted in the body 10 and located at a position below the barbecue grid 20. The heating device 30 can be a fuel heating device or an electric heating device to heat foods on the barbecue grid 20 by fire or electric heating. The heating adjustment unit 35 is connected with the heating device 30 to adjust heat output of the heating device 30.

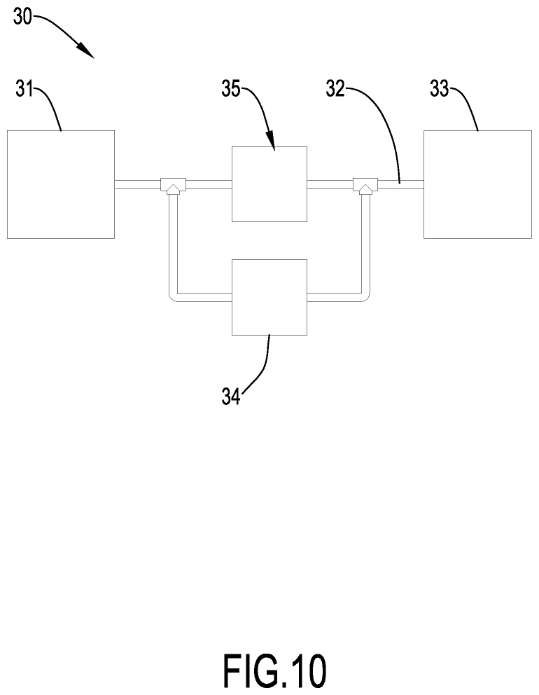

With reference to FIGS. 1, 5, 6, and 10, in the embodiment, the heating device 30 is a fuel heating device, such as a gas heater. The heating device 30 has a fuel supply unit 31 and a burner 33. The fuel supply unit 31 is connected to the burner 33 via a pipe 32. The heating adjustment unit 35 is a flow controller and is connected with the pipe 32 between the fuel supply unit 31 and the burner 33. The heating adjustment unit 35 is adapted to adjust output fuel flow from the fuel supply unit 31 to the burner 33 to increase or decrease the heat output of the heating device 30. The heating adjustment unit 35 substantially has a valve 351 and a stepper motor 353. The valve 351 is connected with the pipe 32 between the fuel supply unit 31 and the burner 33. The stepper motor 353 is connected with the valve 351. The stepper motor 353 drives an adjusting element in the valve 351 to adjust output fuel flow from the valve 351. In addition, a manual valve 34 is connected with the pipe 32 between the fuel supply unit 31 and the burner 33. When the heating adjustment unit 35 is broken or not workable because of power failure, the pipe 32 can be manually opened by the manual valve 34. So fuel can flow through the manual valve 34 to the burner 33.

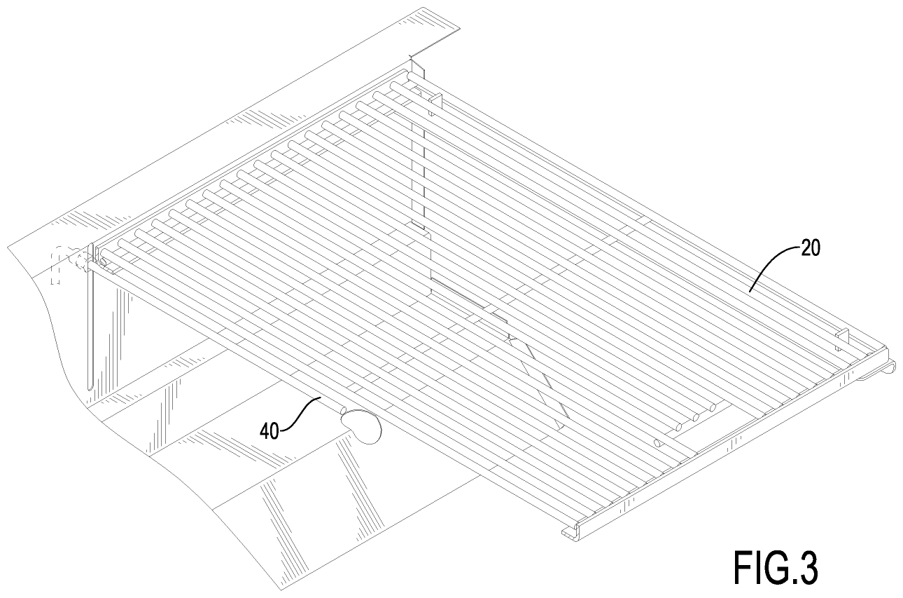

With reference to FIGS. 3, 4, and 8, the thermal sensor 40 is mounted in the body 10 and detects an actual temperature of a position of the thermal sensor 40. Preferably, the thermal sensor 40 is fixed on the barbecue grid 20. The control device 50 has a constant temperature control module 55. The constant temperature control module 55 is electrically connected with the thermal sensor 40 and the heating adjustment unit 35. The constant temperature control module 55 calculates a difference value between a target temperature and the actual temperature of the position of the thermal sensor 40, and controls the heating adjustment unit 35 to adjust the heat output of the heating device 30 according to the difference value. Preferably, the control device 50 is drawably mounted in the body 10. The control device 50 can be pulled out from the body 10 for use, and can be stored into the body 10 after used.

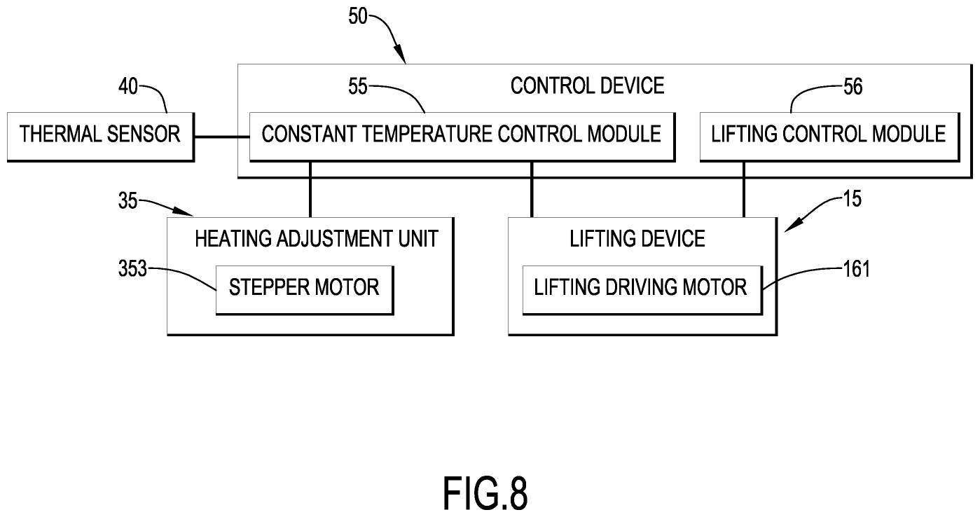

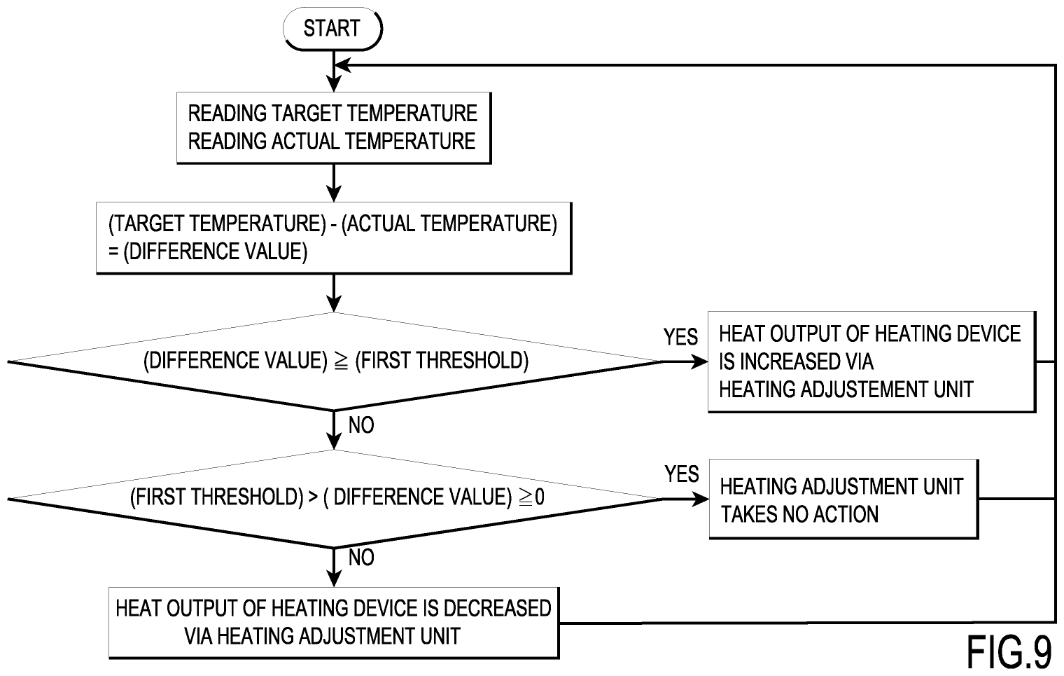

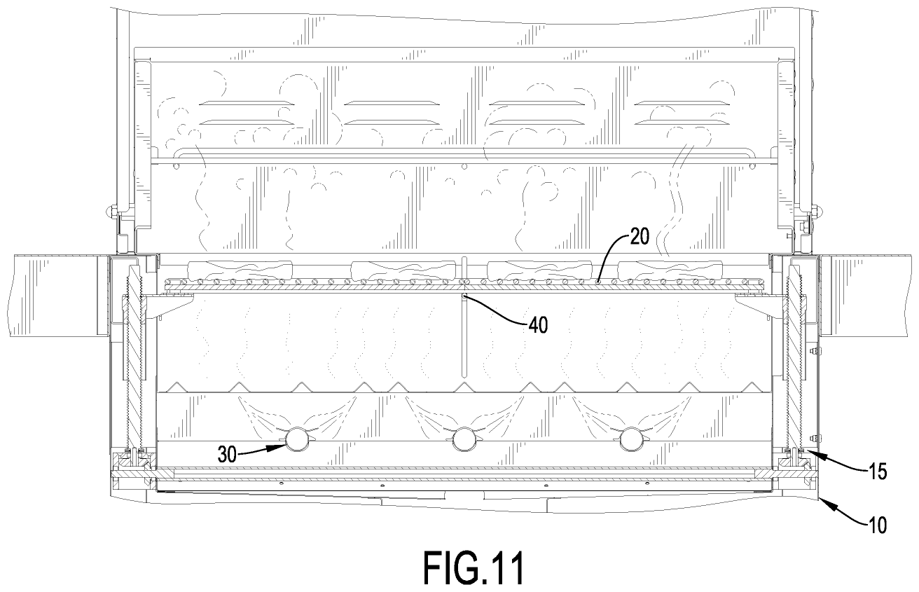

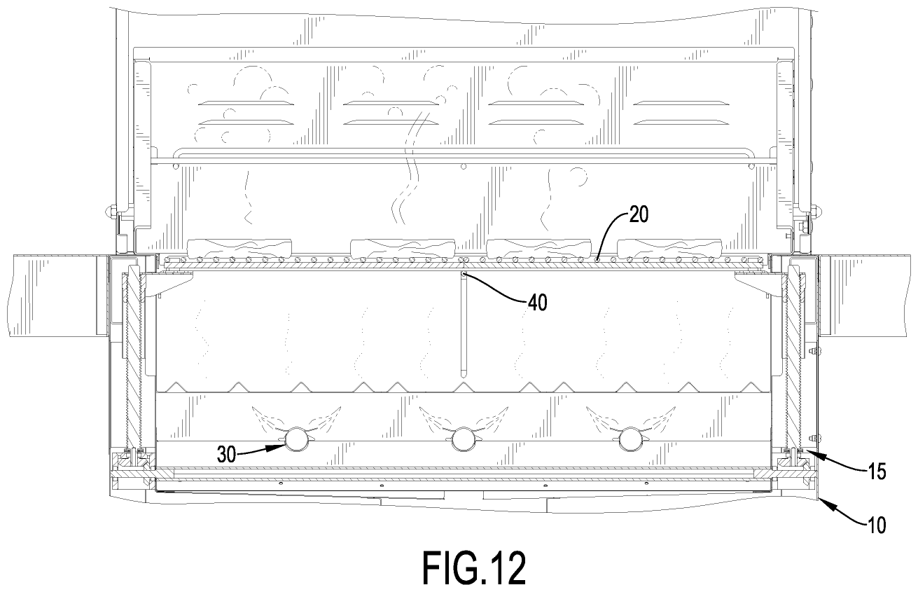

With reference to FIGS. 8 to 12, a user sets a target temperature in the control device 50. The constant temperature control module 55 reads the target temperature and the actual temperature detected by the thermal sensor 40 and calculates a difference value between the target temperature and the actual temperature, wherein the difference value is obtained by subtracting the actual temperature from the target temperature. The constant temperature control module 55 determines whether the difference value is larger than or equal to a first threshold. The first threshold is a positive value, which could be a value greater than 0 and less than or equal to 3. If the constant temperature control module 55 determines the difference value between the target temperature and the actual temperature is larger than or equal to the first threshold, the constant temperature control module 55 will transmit a heating control signal to the heating adjustment unit 35 to control the heating adjustment unit 35 to increase the heat output of the heating device 30. If not, the constant temperature control module 55 will determine whether the difference value between the target temperature and the actual temperature is less than the first threshold and larger than or equal to 0. If the constant temperature control module 55 determines the difference value between the target temperature and the actual temperature is less than the first threshold and larger than or equal to 0, the constant temperature control module 55 will not transmit the heating control signal to the heating adjustment unit 35, and the heating adjustment unit 35 will not take any action. If not, the constant temperature control module 55 will transmit a heating control signal to the heating adjustment unit 35 to control the heating adjustment unit 35 to decrease the heat output of the heating device 30.

In the embodiment, the stepper motor 353 of the heating adjustment unit 35 is electrically connected to the constant temperature control module 55 of the control device 50. The constant temperature control module 55 controls the stepper motor 353 according to the difference value to adjust the fuel flow output from the valve 351. When the difference value is larger than or equal to the first threshold, the constant temperature control module 55 transmits a heating control signal to the stepper motor 353 to drive the stepper motor 353 to increase the fuel flow output from the valve 351. When the difference value is less than the first threshold and larger than or equal to 0, the constant temperature control module 55 will not transmit a heating control signal to the stepper motor 353. The stepper motor 353 will not take any action. When the difference value is less than 0, the constant temperature control module 55 will transmit a heating control signal to the stepper motor 353 to drive the stepper motor 353 to decrease the fuel flow output from the valve 351. After each preset time interval, the constant temperature control module 55 will re-determine the difference value between the target temperature and the actual temperature and control the stepper motor 353 to adjust the fuel flow output from the valve 351 according to the difference value. Accordingly, the heat output of the heating device 30 is adjusted to keep the temperature at the position of the barbecue grid 20 at the target temperature.

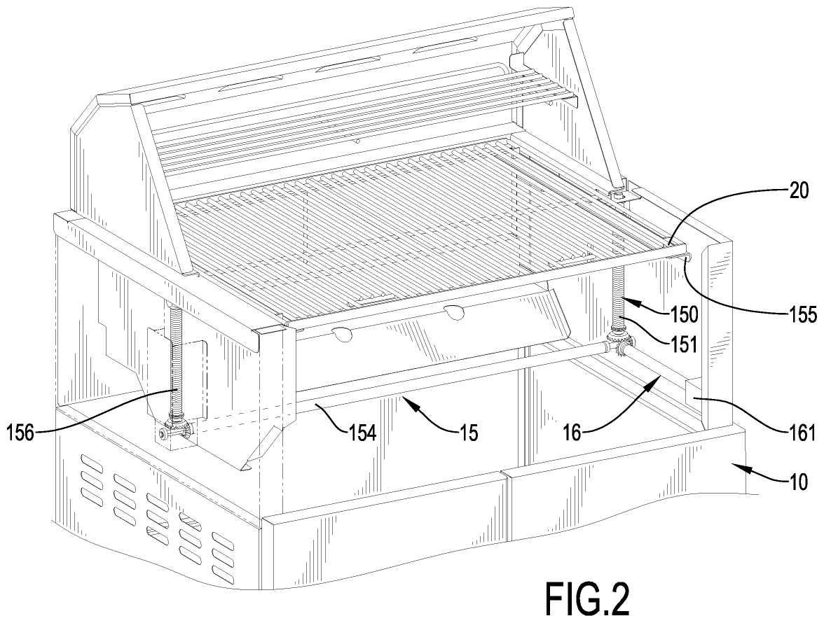

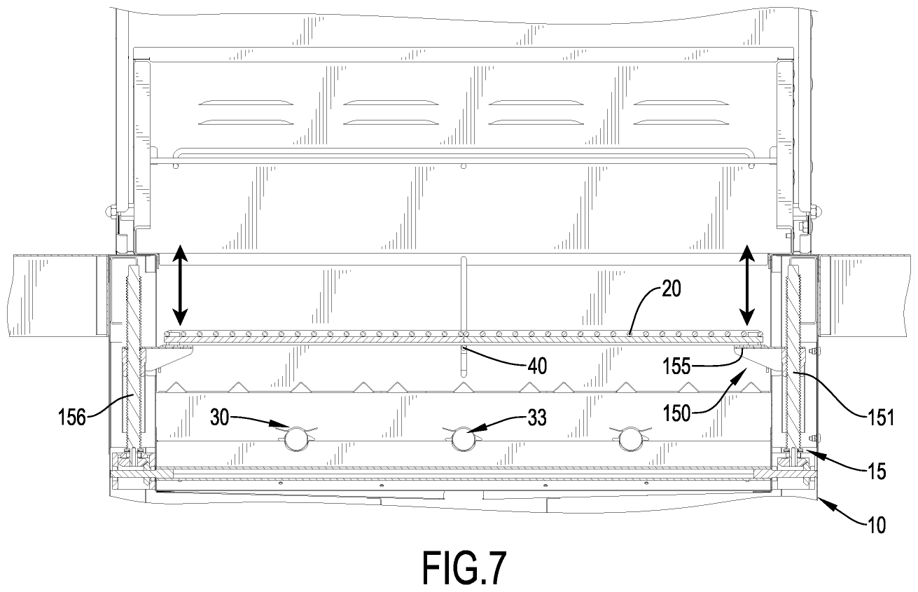

With reference to FIGS. 2, 6, and 7, preferably, the body 10 has a lifting device 15 mounted therein. The barbecue grid 20 is connected to the lifting device 15 and is driven to move up and down relative to the heating device 30 by the lifting device 15. A position of the barbecue grid 20 relative to the heating device 30 can be adjusted by the lifting device 15 to adjust the temperature at the position of the barbecue grid 20.

The lifting device 15 can be a manually controlled lifting device or an automatic lifting device. The lifting device 15 substantially has a lifting assembly 150 and a driving member 16. The lifting assembly 150 has a first leadscrew assembly 151 and a supporting frame 155. The supporting frame 155 is vertically movably connected with the first leadscrew assembly 151. The barbecue grid 20 is held on the supporting frame 155. The driving member 16 is connected to the first leadscrew assembly 151 to drive a leadscrew of the first leadscrew assembly 151 to rotate, and the supporting frame 155 is driven to move up and down relative to the first leadscrew assembly 151. The driving member 16 may be a driving rod for a user to manually drive the lifting device 15. The driving member 16 may be a lifting driving device to drive the lifting device 15.

The lifting device 15 further has a second leadscrew assembly 156 and a linkage member 154. The second leadscrew assembly 156 and the first leadscrew assembly 151 are respectively connected to two opposite sides of the supporting frame 151. Two opposite ends of the linkage member 154 are respectively connected to the first leadscrew assembly 151 and the second leadscrew assembly 156. When the driving member 16 drives the leadscrew of the first leadscrew assembly 151 to rotate, the linkage member 154 is simultaneously driven to rotate and drives a leadscrew of the second leadscrew assembly 156 to rotate. The supporting frame 155 can be stably moved up and down by the simultaneous action of the first leadscrew assembly 151 and the second leadscrew assembly 156.

In the embodiment, the driving member 16 is a lifting driving device and has a lifting driving motor 161 connected to the lifting assembly 150 and electrically connected to the control device 50. The control device 50 controls the lifting driving motor 161 to drive the lifting assembly 150 to vertically move the barbecue grid 20 relative to the heating device 30. The control device 50 has a lifting control module 56. The lifting control module 56 is electrically connected to the lifting driving motor 161 to control an act of the lifting driving motor 161.

Preferably, the lifting driving motor 161 is electrically connected to the constant temperature control module 55. The constant temperature control module 55 controls the lifting driving motor 161 to adjust the position of the barbecue grid 20 relative to the heating device 30 according to the difference value between the target temperature and the actual temperature.

For example, when the constant temperature control module 55 determines the difference value is larger than a second threshold, wherein the second threshold is larger than the first threshold, for example, the second threshold is 30, then, the constant temperature control module 55 will firstly determine whether the supporting frame 155 of the lifting device 15 is located at a lowest position. If not, the constant temperature control module 55 controls the lifting driving motor 161 to move down the supporting frame 155 of the lifting device 15. When the constant temperature control module 55 determines the difference value is less than or equal to a third threshold, wherein the third threshold is smaller than 0, for example, minus 30 (−30), then the constant temperature control module 55 will firstly determine whether the supporting frame 155 of the lifting device 15 is located at a highest position. If not, the constant temperature control module 55 controls the lifting driving motor 161 to move up the supporting frame 155 of the lifting device 15.

With such arrangements, the constant temperature control module 55 can determine whether the actual temperature at the position of the thermal sensor 40 is too high or too low according to the difference value between a target temperature and the actual temperature detected by the thermal sensor 40, and then controls the heating adjustment unit 35 to adjust the heat output of the heating device 30, such that the temperature at the position of the barbecue grid 20 can be kept constant. Preferably, the thermal sensor 40 is fixed on the barbecue grid 20 to keep the position of the barbecue grid 20 at the target temperature. In addition, the body 10 has the lifting device 15 mounted therein. The barbecue grid 20 can be moved toward or away from the heating device 30 by the lifting device 15 to adjust the temperature at the position of the barbecue grid 20.

With reference to FIGS. 8, 11, and 12, the constant temperature control module 55 can automatically adjust the heat output of the heating device 30 and the position of the barbecue grid 20 relative to the heating source. When the actual temperature at the position of the barbecue grid 20 is lower than the target temperature, decrease the distance between the barbecue grid 20 and the heating source and increase heat output of the heating source. When the actual temperature at the position of the barbecue grid 20 is higher than the target temperature, increase the distance between the barbecue grid 20 and the heating source and decrease heat output of the heating source.

What is claimed is:

1. A barbecue grill comprising:
a body;
a barbecue grid held in the body;
a heating device mounted in the body;
a heating adjustment unit connected with the heating device;
a thermal sensor mounted in the body and detecting an actual temperature of a position of the thermal sensor; and
a control device having a constant temperature control module electrically connected to the heating adjustment unit and the thermal sensor, determining a difference value between a target temperature and the actual temperature, and controlling the heating adjustment unit to adjust heat output of the heating device according to the difference value.

2. The barbecue grill as claimed in claim 1, wherein the thermal sensor is fixed on the barbecue grid.

3. The barbecue grill as claimed in claim 2, wherein
the heating device has a fuel supply unit and a burner, and the fuel supply unit is connected to the burner via a pipe; and
the heating adjustment unit is a flow controller and is connected with the pipe between the fuel supply unit and the burner to adjust output fuel flow from the fuel supply unit to the burner.

4. The barbecue grill as claimed in claim 3, wherein
the heating adjustment unit has a valve and a stepper motor, the valve is connected with the pipe between the fuel supply unit and the burner, and the stepper motor is connected with the valve and is electrically connected to the constant temperature control module; and
the constant temperature control module controls the stepper motor to adjust output fuel flow from the valve.

5. The barbecue grill as claimed in claim 4, wherein a manual valve is connected with the pipe between the fuel supply unit and the burner.

6. The barbecue grill as claimed in claim 1, wherein
the body has a lifting device mounted in the body; and
the barbecue grid is connected to the lifting device and is driven to move up and down relative to the heating device by the lifting device.

7. The barbecue grill as claimed in claim 2, wherein
the body has a lifting device mounted in the body; and
the barbecue grid is connected to the lifting device and is driven to move up and down relative to the heating device by the lifting device.

8. The barbecue grill as claimed in claim 3, wherein
the body has a lifting device mounted in the body; and
the barbecue grid is connected to the lifting device and is driven to move up and down relative to the heating device by the lifting device.

9. The barbecue grill as claimed in claim 4, wherein
the body has a lifting device mounted in the body; and
the barbecue grid is connected to the lifting device and is driven to move up and down relative to the heating device by the lifting device.

10. The barbecue grill as claimed in claim 5, wherein
the body has a lifting device mounted in the body; and
the barbecue grid is connected to the lifting device and is driven to move up and down relative to the heating device by the lifting device.

11. The barbecue grill as claimed in claim 6, wherein
the lifting device has a lifting assembly and a lifting driving motor connected to the lifting assembly and electrically connected to the control device; and
the barbecue grid is connected to the lifting assembly.

12. The barbecue grill as claimed in claim 7, wherein
the lifting device has a lifting assembly and a lifting driving motor connected to the lifting assembly and electrically connected to the control device; and
the barbecue grid is connected to the lifting assembly.

13. The barbecue grill as claimed in claim 8, wherein
the lifting device has a lifting assembly and a lifting driving motor connected to the lifting assembly and electrically connected to the control device; and
the barbecue grid is connected to the lifting assembly.

14. The barbecue grill as claimed in claim 9, wherein
the lifting device has a lifting assembly and a lifting driving motor connected to the lifting assembly and electrically connected to the control device; and
the barbecue grid is connected to the lifting assembly.

15. The barbecue grill as claimed in claim 10, wherein
the lifting device has a lifting assembly and a lifting driving motor connected to the lifting assembly and electrically connected to the control device; and
the barbecue grid is connected to the lifting assembly.

16. The barbecue grill as claimed in claim 11, wherein
the lifting driving motor is electrically connected to the constant temperature control module of the control device;
the constant temperature control module controls the lifting driving motor to adjust the position of the barbecue grid relative to the heating device according to the difference value between the target temperature and the actual temperature.

17. The barbecue grill as claimed in claim 12, wherein
the lifting driving motor is electrically connected to the constant temperature control module of the control device;
the constant temperature control module controls the lifting driving motor to adjust the position of the barbecue grid relative to the heating device according to the difference value between the target temperature and the actual temperature.

18. The barbecue grill as claimed in claim 13, wherein
the lifting driving motor is electrically connected to the constant temperature control module of the control device;
the constant temperature control module controls the lifting driving motor to adjust the position of the barbecue grid relative to the heating device according to the difference value between the target temperature and the actual temperature.

19. The barbecue grill as claimed in claim 14, wherein
the lifting driving motor is electrically connected to the constant temperature control module of the control device;
the constant temperature control module controls the lifting driving motor to adjust the position of the barbecue grid relative to the heating device according to the difference value between the target temperature and the actual temperature.

20. The barbecue grill as claimed in claim 15, wherein
the lifting driving motor is electrically connected to the constant temperature control module of the control device;
the constant temperature control module controls the lifting driving motor to adjust the position of the barbecue grid relative to the heating device according to the difference value between the target temperature and the actual temperature.
